(19) United States
(12) Patent Application Publication
(10) Pub. No.: US 2010/0330041 A1
(43) Pub. Date: Dec. 30, 2010

(54) Viral-based antimicrobial agent use in ethanol production

(76) Inventor: Dennis P. Bayrock, Rosemount, MN (US)

Correspondence Address: CHRISTOPHER G. HAYDEN, ESQ.;HAYDEN STONE PLLC, 2212 Mt Vernon Ave, Suite 5, Alexandria, VA, 22301, US

(21) Appl. No.: 12/801,180

(22) Filed: May 26, 2010

Related U.S. Application Data
(60) Provisional application No. 61/213,290, filed on May 27, 2009.

(51) Int. Cl. A01N 63/00; A01P 1/00

(52) U.S. Cl. 424/93.6

(57) ABSTRACT

A process of controlling unwanted microorganism contamination in the fermentation of mash to form ethanol, particularly to control lactobacilli contamination, is achieved by adding viral agents adapted to destroy or deactivate lactobacilli and/or other selected microorganisms. The amount of viral agents added is sufficient amount to keep the presence of the undesired microorganisms, particularly the Lactic Acid Bacteria Family and more particularly lactobacilli, to a level below about 5 times 10⁶ viable cells per milliliter of mash, for example to a level below about 1 times 10⁶ viable cells per milliliter of mash, during fermentation. The treatment may include bacteriophages and one or more of stabilizers such as trehalose, sucrose, maltose, glycerol, divalent alkaline earth metal salt, or salts of gluconic acid.

The application claims priority to provisional application 61/213,290 filed on May 27, 2009, the entire contents of which is incorporated by reference thereto.

### FIELD OF THE INVENTION

The invention relates to a process of controlling unwanted microorganism contamination in the fermentation of mash to form ethanol, particularly to control lactobacilli contamination, by adding viral agents adapted to destroy or deactivate lactobacilli and/or other selected microorganisms in an amount sufficient amount to keep the presence of the undesired microorganisms, particularly the Lactic Acid Bacteria Family and more particularly lactobacilli, to a level below about 5 times 10⁶ viable cells per milliliter of mash, preferably to a level below about 1 times 10⁶ viable cells per milliliter of mash, during fermentation.

### BACKGROUND OF THE INVENTION

Ethanol production through anaerobic fermentation of a carbon source by the yeast Saccharomyces cerevisiae is one of the best known biotechnological processes and accounts for a world production of more than 35 billion liters per year. Two thirds of the production is located in Brazil and in the United States with the primary objective of using ethanol as a renewable source of fuel. Hence, there are strong economic incentives to further improve the ethanol production process. The price of the sugar source or carbohydrate source is a very important process parameter in determining the overall economy of ethanol production. Using unaltered yeasts, the greatest yield obtainable is only about 51.1%, with the remainder being lost to yeast maintenance and growth, glycerol production, undesired byproducts, and other end products. The typical ethanol yield is lower than the above-described maximum theoretical yield in large part due to competing microorganisms.

A typical ethanol production plant comprises a premixing vessel where water and the carbohydrate fuel source (hereafter referred to as mash) are held at 40° C. to 60° C. and where (if corn is the source of carbohydrate) a small amount of enzyme such as a-amylase is added. The mash is then heated to between 90° C. to 150° C. for a period of time, and then cooled and held between 80° C. to 90° C. as the mash liquifies. The mash is then cooled to 60° C. and additional enzymes may be added in a saccharification step. After a period of time at 60° C., the mash is cooled to ambient to −35° C., and the liquid is then sent to fermenters where yeast is added to convert sugars to ethanol. In a continuous process utilization of a number of serially linked fermenters is typical, as this is required for efficient conversion of the sugars and also because ethanol-production-favorable conditions (which depend on the amount of alcohol and other byproducts present in the mash) can be optimized. Finally, the alcohol/water fraction is sent to a distilling column where alcohol is extracted, and the residual material find large markets in the animal feed business. Large volumes are processed, and as one might imagine with all the temperature changes involved in the process that heat exchangers are critical to both net production of energy and to the economics of the process.

The economic viability of the ethanol production process, and indeed whether the process results in positive production of fuel source, depends to a large extent on the recovery and re-use of the latent heat of the mash. This recovery and re-use of heat energy is performed by use of heat exchangers, which are typically installed in the process to maximize the recovery of high quality heat. A substantial problem faced by the industry is that in certain units, for example where mash is held at 90° C. to 150° C., most antimicrobial agents added to the mash would be inactivated and destroyed by the heat. In liquefaction and saccharification units operating at 90° C., this is only a minor problem as lactobacilli and other microorganisms can not thrive at those temperatures. However, lactobacilli and other microorganisms can colonize and thrive in the numerous other heat exchangers poised at lower temperatures. There is no practical method, using powdered antimicrobial agents, of providing an active concentration of the antimicrobial agent to mash passing through heat exchangers immediately following units operated at high temperatures. The kinetics of dissolution of these antimicrobial agents are too slow to provide an effective concentration of these antimicrobial agents in the time frame where the mash passes through the heat exchangers, so effective control of lactobacilli and other microorganisms in these first heat exchangers is not readily achieved using the most effective current antimicrobial products (pristinamycin-type antimicrobial agents, polyether ionophore-type antimicrobial agents, or both). In other currently pending U.S. application Ser. Nos. 11/806,591 and 11/806,592, use of micronized and/or presolubilized pristinamycin-type antimicrobial agents, polyether ionophore-type antimicrobial agents, or both, injected (by batch, pulse, or continuous means) immediately upstream of or even within the body of the heat exchangers, addresses this problem. These applications are incorporated herein by reference thereto for all permitted purposes.

Finally, the fermented mash (containing corn particles, alcohol, and water) is sent to a distilling column where alcohol is extracted, and the dried residual material find large markets in the animal feed business as DDG.

Large volumes are processed, and as one might imagine with all the temperature changes involved in the process that heat exchangers are critical to both net production of energy and to the economics of the process. Similar use can be made in other areas of the plant, and in other unit operations in plants having different configurations, where there is a need to provide in a short period of time an effective concentration of pristinamycin-type antimicrobial agents, polyether ionophore-type antimicrobial agents, or both.

One particularly difficult problem is the control of competing microorganisms, in particular bacteria of the LAB (Lactic Acid Bacteria family) which encompasses many bacterial species of similar growth and physiological traits. One example is Lactobacillus paracasei which compete with the yeast for nutrients and produce lactic acid. Other microorganisms such as Acetobacter/Gluconobacter and wild yeasts must also be controlled. Since control of LAB is critical to the process viability and since control of one class of microorganisms by the methods described here results in control of at least some of the other microorganisms, this discussion will focus on LAB control. One of skill in the art will know that a number of other competing microorganisms will also be controlled by the treatment processes described here, depending on the antibiotics and antimicrobials used in the process. LAB bacterial contamination in the range of 10⁶ to 10⁷ per ml can reduce ethanol yield by 1-3%. LAB bacteria are present in all incoming carbohydrate sources, and are present in all areas of the ethanol production plant. In industrial processes such as the manufacture of ethanol for fuel, even with active control programs to control the proliferation of LAB bacterial, carbohydrate losses to LAB bacterial can range up to several percent of the total carbohydrate input, which can make the difference between profitability and non-profitability. Further, if the lactic acid content of the mash approaches 0.8% and/or acetic acid concentration exceeds 0.05%, the ethanol producing yeast are stressed and yeast metabolism is reduced. In the manufacture of certain alcoholic beverages, the proliferation of lactobacilli and its byproducts can unfavorably alter the taste and value of the product.

Control of competing microorganisms, in particular Lactobacillus spp., which compete with the yeast for nutrients and produce lactic acid, is difficult. Lactobacilli produce most of the energy required for its growth solely by the glycolytic breakdown of sugars into lactic acid. Lactobacilli contamination in the range of 10⁶ to 10⁷ per ml can reduce a facility's ethanol yield by 1-3%. Lactobacilli are present in all incoming carbohydrate sources, and are present in all areas of the ethanol production plant.

Other microorganisms such as Acetobacter/Gluconobacter and wild yeasts must also be controlled. Since control of lactobacilli, other lactic acid bacteria family species, Acetobacter/Gluconobacter and wild yeasts is critical to the process viability and since control of other classes of microorganisms by the methods described here is straightforward, this discussion will focus on lactobacilli control.

One effective control program involves the introduction of pristinamycin-type antimicrobial agents such as virginiamycin to the mash. These pristinamycin-type antimicrobial agents are very effective against a number of microorganisms including lactobacilli at low concentrations, e.g., 0.3 to 5 ppm, and the antimicrobial agent does not significantly hinder the yeast. Further, microorganisms do not tend to develop resistance to this type of antimicrobial agent, and the antimicrobial agent is effectively destroyed by the drying of the end “waste” product so that it is not introduced indiscriminately into the environment. Other control agents used in the industry include tetracycline-based antibiotics, streptomycin, penicillin-based antibiotics (e.g., G, V, or N), and bacitracin. These are not favored because microorganisms can quickly develop tolerances and presence of microorganisms that are resistant to these antibiotics can create problems with the public perception and with some uses of the waste or residual material after fermentation as animal feed.

The use of antibiotics, however, can eventually result in the evolution of very resistant microorganisms.

Nature provides two effective natural controls to microorganisms including lactobacilli. The first natural control is that eventually the environment becomes hostile—the availability of nutrients decreases and the presence of waste material (both from lactobacilli and ethanol from yeast) increases. Unfortunately, even though the desired ethanol-producing yeast is given a significant head start by a large inoculating population, the mash used to provide the feedstuff for yeast-based ethanol production is so rich in nutrients that this “control” does not become significant until long after the damage has been done—that is, until long after an economically significant portion of the nutrients in the mash have been converted to lactic acid and other material by lactobacilli.

The second natural control is the presence of other species that in turn prey on the microorganisms including lactobacilli. It is difficult to find larger microorganisms that will prey on lactobacilli but will not also attack yeast. Viruses are a natural inhibitory force on a variety of organisms, including lactobacilli. Viruses are known to be very genus-specific and even species-specific. That is, viral units that attack various Lactobacilli but have no effect on ethanol-producing yeast are readily available.

Without suggesting that dairies are in the same field of endeavor as alcohol fermentation, Lactobacilli and lactococcal phages are always present in dairies. Indeed, these organisms may be encouraged—lactobacilli are used for example to make cheeses and yogurt. Lactococcus phages are the prime cause of cheese fermentation failures. In a 2003 study in Poland, a test of whey samples for the presence of bacteriophages, using 15 different strains of lactococci, uncovered 10³-10⁹ phages/ml in 21 of 22 samples tested. Cheese factories using Lactococcus lactis can be contaminated with high levels of phages. “Monitoring and characterization of lactococcal bacteriophage in a dairy plant” by H. Neve, U. Kemper, A. Geis, and K. J. Heller (in Kiel. Milchwirtsch. Forschungsber. 46:167-178. (1994)) reported up to 10⁹ phage per ml of whey and up to 10⁵ phage per m³ in the air. Skinner K. A. et al. in Bacterial contaminants of fuel ethanol production (J Ind Microbiol Biotechnol, 2004 Oct., 31(9), 401-8) described how bacterial contamination is an ongoing problem for commercial fuel ethanol production facilities. Both chronic and acute infections are of concern, due to the fact that bacteria compete with the ethanol-producing yeast for sugar substrates and micronutrients. Samples that were collected from one wet mill and two dry grind fuel ethanol facilities over a 9 month period at strategic time points and locations along the production lines, and bacterial contaminants were isolated and identified. Contamination in the wet mill facility consistently reached 10⁶ bacteria/ml. Titers from dry grind facilities were more variable but often reached 10⁸ /ml

Strains of Lactococcus lactis are used by the dairy industry to acidify milk during the manufacture of fermented products, such as cheese, buttermilk, and sour cream. Lactobacillus bacteria are also commonly used for yogurt production. When the phage titers exceeded 10³ PFU/ml, the yogurt fermentation process was delayed and came to a stop at higher phage titers, leading to important economical losses. Lactococcal phages are ubiquitous in the dairy environment, as they are found in raw milk and survive pasteurization. Due to their negative effects on fermentation as well as their biodiversity within this ecological niche, numerous lactococcal phages have been isolated and characterized, with the overall aim of improving phage control strategies. Many Lactobacillus viruses have been isolated since the 1950's by the dairy industries after they caused (and still cause) entire yogurt production facilities to shut down for CIP due to the destruction of the desired lactobacillus bacteria culture. Many academic papers exist that document these viruses, their life cycle, specificity, and damage to the yogurt industry.

In fact, Lactobacilli and Lactococcal phages can be considered to be ubiquitous in nature. Several hundreds of characterized L. lactis phages are members of the Caudovirales order and of the Siphoviridae family. Interlaboratory phage comparisons led to the definition of 12 lactococcal phage species. Different types of prolate-headed and large and small isometric-headed Siphoviridae (phages with long noncontractile tails) and rare Podoviridae (phages with short tails) have been described in dairy/cheese literature. In meat fermentation, Myoviridae (phages with contractile tails) infect Lactobacillus starters.

In “Growth Characteristics of Lactococcal Phages Isolated from the Dairy Sources in India,” by Ramesh S. Bhimani and Yvonne M. Freitas (Journal of Dairy Science Vol. 76 No. 11 3338-3349 (1993)), the authors studied four lactococcal phages (FRC1, FRC2, FRC3, and FRC4) and found adsorption was maximum at 30° C. and pH of 7.2 to 7.6 after 10 min. Optimal growth temperatures of the host and phage were 37° C. Thermal death points of the phages were in the range of 65 to 80° C. In broth and skim milk, thermal death points were 5 to 10° C. higher. The latent period, eclipse phase, rise period, and burst uses of these phages were 40 to 45 min, 22 to 32 min, 15 to 20 min, and 70 to 150 min, respectively. An average phage life cycle in milk is therefore about 2.5 to 4 hours after infection. Burst size decreased 15 to 37% at 33° C. and 50 to 64% at 37° C. Lactococcal hosts challenged with homologous phages showed greatly decreased culture turbidity and lowered acid production (42 to 61%).

A typical ethanol production plant comprises a premixing vessel where water and the carbohydrate fuel source (hereafter referred to as mash) are held at 40° C. to 60° C. and where (if corn is the source of carbohydrate) a small amount of enzyme such as a-amylase is added. The mash is then heated to between 90° C. to 150° C. for a period of time, and then cooled and held between 80° C. to 90° C. as the mash liquifies. The mash is then cooled to 60° C. and additional enzymes may be added in a saccharification step. After a period of time at 60° C., the mash is cooled to ambient to −35° C., and the liquid is then sent to fermenters where yeast is added to convert sugars to ethanol. In a continuous process utilization of a number of serially linked fermenters is typical, as this is required for efficient conversion of the sugars and also because ethanol-production-favorable conditions (which depend on the amount of alcohol and other byproducts present in the mash) can be optimized. Finally, the alcohol/water fraction is sent to a distilling column where alcohol is extracted, and the residual material find large markets in the animal feed business.

Lactobacilli are always present in mash. Therefore, Lactococcal phages are always present in mash unless deactivated by heat, alcohol, or other agents. In nature, and in the mash, the population of lactococcal phages will lag significantly behind the population explosion of lactobacilli in the ideal mash environment. The step of holding the mash at a temperature of 90° C. to 150° C. for a period of time, and then held between 80° C. to 90° C. as the mash liquefies, will (based on the data of Bhimani and Freitas) also substantially reduce the number of active phages naturally present. When lactiobacilli subsequently proliferate, the viruses that attack lactobacilli will eventually also proliferate. However, in environments such as mash where conditions affecting cell growth are optimum, the generation of Lactococcal phages will lag behind the growth of the undesirable lactobacilli, and therefore the small amount of Lactococcal phages naturally present after saccharification does not provide an effective control of the Lactobacilli.

What is needed is an effective method of controlling lactobacilli levels in alcohol fermentation mash to levels below quantities that unduly reduce or impair ethanol production by yeast.

### SUMMARY OF THE INVENTION

The invention is the addition of active viruses, or partially deactivated viruses, weakened viruses, or mixtures thereof, hereafter “active phages,” to mash in an ethanol production facility, where the active phages inhibit growth, metabolism, and/or reproductive capacity, of undesired microorganisms to an acceptable level while having substantially no effect on ethanol-producing microorganisms. The invention includes a method of adding a sufficient number of the active (lactococcal) phages or viruses to destroy any bacteria (e.g., Lactic acid bacteria family, particularly focusing on Lactobacillus) present as a contaminant in mash in the fuel ethanol industry.

More particularly, the invention is the addition of active and/or partially deactivated lactococcal phages to mash in an ethanol production facility, where the viruses and viral products are targeted to attack and inhibit lactobacilli while having substantially no effect on ethanol-producing yeast. The invention relates to a process of controlling unwanted microorganism contamination in the fermentation of mash to form ethanol, particularly to control lactobacilli contamination, by adding viral agents adapted to destroy or deactivate lactobacilli and/or other selected microorganisms in an amount sufficient amount to keep the presence of the undesired microorganisms, particularly lactobacilli, to a level below about 5 times 10⁶ viable cells per milliliter of mash, preferably to a level below about 1 times 10⁶ viable cells per milliliter of mash, more preferably to a level below about 5 times 10⁵ viable cells per milliliter of mash, during fermentation. Primary application of the viral product would be in the fermentors/propagators where the level of complicating factors (heat, alcohol content) is lower than at other areas of the plant. Also, the fermentors and propagators are where lactobacilli are most vigorous in metabolic activity and life—which are the best conditions to allow for a viral infection. Advantageously the active phages are added after the mash has been cooled to at least 60° C., more preferably after the mash has been cooled to 40° C. or lower.

The amount of said lactococcal phages added to the mash (the initial treatment dose) should be at least 1 times 10³ phages per ml, for example at least 1 times 10⁴ phages per ml, or for example at least 1 times 10⁵ phages per ml, and preferably at least 1 times 10⁶ phages per ml. As lactobacilli are infected and burst, the amount of active phages will increase to levels above the initial treatment dose. The optimum time to add the viral product will depend on the product specifications (e.g., types of viruses, a dry product or a liquid suspension), but should generally be added just prior to fermentation.

A preferred method of adding the phages is in the form of an aqueous suspension (the liquid acts like a solution) with protein stabilizing agents (to protect virus protein exterior shell for stability). Suitable protein stabilizers, which may in one embodiment be present in an amount between 0.1% to 50%, for example from 1-10% by weight concentration) for consideration include trehalose, sucrose, maltose, glycerol. In another embodiment the treatment can encompass a dry product using trehalose as a phage protectant, for example 5% to 80% by weight trehalose, preferably 10% to 30% by weight, for example at a 20% w/w composition, balance the phages.

Active ingredient is preferably a cocktail (plurality) of different LAB bacteriophages, for example 2 to 10 bacteriophage types, or alternatively 4 to 8 bacteriophage types.

Aqueous compositions comprise at least one bacteriophage and a suitable carrier, including, for example, a buffer, such as, for example, phosphate buffered saline, broth, or water. Other adjuvants known to stabilize a bacteriophage such that the bacteriophage remains viable to attack include a buffering agent that controls a pH level of the bacteriophage treatment in order to sustain the bacteriophage in the aqueous solution. A suitable pH range for the bacteriophage treatment is between approximately 4 and 9. Divalent alkaline earth metal salts and salts of gluconic acid are also useful in some embodiments. Non-aqueous compositions include, but are not limited to, lyophilized compositions or spray-dried compositions comprising at least one bacteriophage. The composition may be a suspension, coating or in tablet, capsule or powder form.

The viral product can advantageously be added in the propagator/fermentor at an ethanol facility. The viral product would target LAB bacteria, particularly lactobacilli, though it may be beneficial to additionally target one or more of Clostridium, Bacillus, and Streptococci (a part of the LAB family) bacteria.

There are two general types of viruses—lytic and lysogenic—useful for this treatment process. Of the two types of viruses it is the lytic viruses have the greatest activity to control contamination. The preferred product is a “cocktail” comprising several viruses specific against the number of different Lactobacilli that have been isolated from fuel ethanol plants. Viruses and/or viral products which target other pests, including certain wild yeasts, can optionally be included in the cocktail.

For quality control of a commercial product and control of the process, it is beneficial to limit the number of viruses or viral products added to the mash. However, a single virus product would work against a specific Lactobacillus bacteria or classes of Lactobacillus bacteria, but would not impair the different remaining Lactobacillus bacteria. The result (in the cases where there is recirculation of some mash) would be a gradual buildup of the population of unaffected lactobacilli.

On the other hand, if mash is not recirculated but is fermented as a batch system, buildup of non-affected yeast will generally not be an issue.

Precedence that a viral product may work in the fuel ethanol industry is found in the dairy industry. These viruses from the dairy industry form the backbone of the proposed treatment product and process. In a very preferred embodiment, no genetic/chemical modifications should be needed on existing viruses. That does not suggest that the viruses will not naturally adapt over time. The “biological war” between lactobacilli which are ubiquitous in the dairy industry and the phages which attack them has been documented by a number of researchers. As lactobacilli adapt to (become resistant to) certain viruses, the viruses mutate to regain effectiveness. Therefore, the viral product is expected to evolve over time. One method of maximizing the effectiveness of the product is to select phages based at least in part based on phase effectiveness in mash, by using treated mash to provide source phages, where the phages can subsequently be multiplied into concentrated suspensions and made into a viral product.

As the viruses are naturally present, there is no regulatory obstacles for use. The added virus(es) is/are specific to Lactobacillus bacteria—Saccharomyces production yeasts are not affected. One or more of the added viruses is active against any live bacteria—multiplying or non-multiplying. Of course, the added virus(es) is/are specific to Lactobacillus bacteria so human contact is not an issue.

Usually, the “waste” byproduct, known as “Dried Distillers Grains with Solubles (DDGS), is sold as animal feed, going 45% to dairy, 35% to beef, 15% to swine, and 5% to poultry industries. The sale of DDGS is an important factor in the profitability of an ethanol production process, and the total amount of this byproduct produced per year is on the order of 3.5 million metric tons per year. The presence of residual various foreign agents in this material can adversely affect the value of this byproduct. Lactococcal phages are ubiquitous in the dairy environment, as they are found in raw milk and survive pasteurization. However, the virus would decompose rapidly during distillation as these viruses are extremely sensitive to heat when ethanol is present. Viral decomposition products are protein and DNA—neither of which is a concern for DDG feed to animals.

In some cases very low dosages are needed. In these cases the viruses are active while the lactobacilli are quasi-dormant, and a single virus infecting a bacterial cell will produce hundreds of viruses that will be released once the host cell is destroyed. Thus the population of viruses will geometrically increase over time. In cases where the virus product is underdosed, the virus numbers will geometrically increase over time to conquer the load of bacteria present. Thus the amount of virus is not static over time unlike chemical additions. However, the viral population is self-limiting as a virus can only multiply if host bacteria are present. Once the bacteria are eliminated, the viruses cannot multiply. Thus an “out of control” growth of viruses is not possible.

Viral product will not likely survive distillation process and so would not be in active form in any recycle streams in the plant. Thus viral product addition needs to be maintained at the plant at the prescribed addition points.

Advantageously at least an effective number of the added viruses do not inactivate due to the denaturing of the protein shell by ethanol, at least at low ethanol concentrations (e.g., less than 3% by weight, alternatively less than 1% by weight.). Similarly, advantageously at least an effective number of the added viruses do not inactivate due to the denaturing of the protein shell caused by the pH of the mash during normal fermentation.

In a preferred product the virus-containing product will by dry and will not need special refrigeration. Virus typically exists in dormant state and its shelf life of such a product at normal plant storage conditions can be months. In another preferred embodiment the viral product is a liquid suspension. Such viruses will typically become active in the mash in a much shorter time than dry dormant viruses. Generally, a concentration of 10⁹ -10¹² phages per ml is desired for a liquid viral product.

In one embodiment the product additionally contains bulk yeast extract which contains proteins and DNA. In another embodiment the viral product additionally comprises calcium, that is, at least 1% calcium by weight.

In more preferred embodiments, the product is a multiple viral product to target a host of contaminants (broad spectrum action) and to target a particular bacterial with multiple virii (redundancy of action). According to the International Committee on Taxonomy of Viruses, L. lactis phages are members of the Caudovirales order, an extremely large, morphologically and genetically diverse group that encompasses over 95% of all known phages (37). This order contains three families, namely, the Myoviridae (with long, contractile tails), the Siphoviridae (with long, noncontractile tails), and the Podoviridae (with short tails). Lactococcal phages are mainly members of the Siphoviridae family, with a few members from the Podoviridae family. Lactococcal phages have been reclassified recently into 10 genetically distinct groups of dsDNA and tail-containing phages. However, members of only three L. lactis phage groups (936, c2, and P335) are regularly isolated. While virulent members of the 936 and c2 groups are rather homogeneous, there is considerable genetic heterogeneity in members of the P335 group, which contains both temperate and lytic phages.

Three predominant groups (936, c2, and P335) account for 98% of known lactococcal phages and are responsible for most dairy fermentation breakdowns/Advantageously in one embodiment the viral product which is added to mash in ethanol production for fuel contains representatives of at least two of the 936, c2, and P335 L. lactis phage groups, more preferably from each of the 936, c2, and P335 L. lactis phage groups. Other viruses may also be present in the product to provide resiliency, for example, lactococcal phages of the Podoviridae family (P034 and KSY1) which have a long latent period may be included.

While many of the viruses are expected to be obtained from the dairy industry, the presence of viruses that can contaminate fermenting mash are particularly desired as they are known to be resistant to ethanol. Such viruses are described in for example Watanabe K.; S. Takesue; K. Jin-Nai; and T. Yoshikawa in Bacteriophage active against the lactic acid beverage-producing bacterium Lactobacillus casei. (Appl. Microbiol., vol. 20, pp. 409-415, 1970). Lee also demonstrated the existence of temperate phages in L. casei and L. hilgardii strains isolated from wine, as described in Lee A.; Bacteriophages associated with lactobacilli isolated from wine (5th Int. Oenolog. Symp., Auckland 1978, p. 287-295. Aust. N. Z. Ass. Advance Sci., 1978). Also expected to be useful are phages described by Louise Nel, Brenda D. Wingfield, Linda J. van der Meer, H. J. J. van Vuuren (1987) in Isolation and characterization of Leuconostoc oenos bacteriophages from wine and sugarcane.

Useful lactococcal phage species identified by the improved classification scheme are shown in the table below. At least two, preferably at least three, phage types should be present in the viral product.

| Family | Phage | Species | L. lactis host strain |
|---|---|---|---|
| Siphoviridae | bIL170 | 936 | IL1403 |
| | c2 | c2 | LM0231 |
| | CB17 | c2 | SMQ-436 |
| | GR6 | c2 | SMQ-361 |
| | 1483 | P335 | 111 |
| | r1t | P335 | R1K10 |
| | T189 | P335 | 205.RV |
| | ul36 | P335 | SMQ-86 |
| | BK5-T | P335 | H2 |
| | 949 | 949 | ML8 |
| | bIL168 | 949 | IL-16 |
| | P087 | P087 | C10 |
| | 1358 | 1358 | 582 |
| | 1706 | 1706 | SMQ-450 |
| | Q54 | Q54 | SMQ-562 |
| Podoviridae | 1138 | P034 | SMQ-450 |
| | P369 | P034 | F7/2 |
| | KSY1 | KSY1 | IE-16 |

The viral products are expected to be useful in traditional mash fermentors and in other processes, e.g., in processes using the engineered (to also catabolize pentoses) anaerobic bacterium Zymomonas mobilis for the microbial production of ethanol fuel.

Purified suspensions of phages may be obtained from research centers or culture/phage collections. Lytic bacteriophages specific for pathogenic bacteria may be isolated by the methods described in U.S. Pat. No. 6,699,701. They are generally in freeze-dried form or suspended in broth, whey or other liquid. It is more convenient to work with liquid preparations than freeze-dried preparations. Note freeze-drying almost invariably results in a significant drop in titre.

A method of acquiring lactococcal phages can be found in Growth Characteristics of Lactococcal Phages Isolated from the Dairy Sources in India, by Ramesh S. Bhimani and Yvonne M. Freitas in the Journal of Dairy Science Vol. 76 No. 11 3338-3349 (1993). Phages were stable at 4° C. for 2 mo and 14 to 16 mo at −20° C. Phages survived 4 to 5 d under dry conditions. The preparation of large quantities of high titre phage lysates or the maintenance of existing phage stocks may be performed in broth or milk-based media. In general, broth media are more convenient to work with. However, milk media are useful in some instances.

Bottles containing 10 ml of reconstituted skim-milk (RSM) are inoculated with 4% culture and infected with sufficient phage to give 10²-10³ pfu/ml. Higher concentrations of phage may be added but may give a lower yield of virus. At higher phage concentrations, sufficient phage replication to give maximum titre may not occur due to early cell lysis. Too low a concentration may allow host cells to grow and produce enough acid to inhibit phage production. Infected cultures are incubated at the optimum temperature for phage production. Incubation at about 30° C. for 6 h will generally give satisfactory results for most phages. At this time, 1 ml of a 5% (v/v) solution of lactic acid is added to precipitate casein and the whey, containing phage, separated from the coagulum by centrifugation. The whey may be neutralised a base. Neutralisation, however, may not extend storage life nor reduce the drop in phage titre during storage. Lysates may be freed from bacteria by membrane filtration using membranes with a pore size of 0.45 mμ. This method generally gives phage lysates containing 10⁹-10¹¹ pfu/ml.

Incubation temperatures in excess of 30° C. may also be used, and may give higher titres for some phages. Extended incubation times at 30° C. and above are not advisable because of the possibility of secondary growth occurring. Even higher titres, in excess of 1012 pfu/ml for some phage-host systems can be obtained by adding β-disodium glycerophosphate (GP) to the RSM. The addition of GP increases the buffering capacity and by adjusting the phage to cell ratio, marked increases in phage yield can be obtained. RSM containing 1% (v/v) solution is suggested for initial evaluation.

Several broth media are suitable for producing phage lysates. These include M17 and PLGYG. The latter is also known as modified MRS. Broth media are more convenient to use than milk-based media since protein removal prior to membrane filtration is not required. All broth media should be supplemented with calcium prior to use. Supplementation using calcium chloride or calcium borogluconate solutions to give 5 mM Ca++ is recommended for M16 and PLGYG, and 10 mM is useful for M17 broth. Higher Ca++ concentrations may give higher yields of phage for some phage-host systems. Unlike traditional media, M17 and PLGYG do not contain buffers which chelate Ca++ which is required for phage replication. M17 and PLGYG are buffered with β-disodium glycerophosphate (GP). Higher phage concentrations, for some phage-host systems, may be obtained by using lower concentrations of GP in M17 or using PLGYG.

The following method is recommended for producing high titre phage suspensions in broth. Bottles containing 10 ml of PLGYG (+5 mM Ca++) are inoculated with 1% culture and infected with 10³-10⁶ pfu/ml of phage, which is then incubated at 30° C. Mass lysis or clearing of the culture generally occurs after 2-4 h incubation. Time depends on the initial phage titre, the particular phage-host system and the calcium concentration used. With some old phage suspensions, especially if stored under acidic conditions, two propagation's in broth may be necessary. The need for a second propagation in broth will be apparent if mass lysis does not occur by 6 h incubation. After 6 h incubation, centrifuge to remove cell debris and bacteria, whereupon the lysates can be filtered to remove bacterial contaminants. Some suspensions may be very viscous. Nuclease enzymes degrade the DNA. Phage preparations produced by this method generally have titres ranging from 10⁹-10¹¹ pfu/ml.

Said phage preparations can then be mixed to obtain the desired multi-phage, high titre product which can be used to introduce a high and effective titre of lactococcal phages (and other desirable phages as needed) to mash prior to or near the beginning of the fermentation process.

There are a number of problems with treating mash or other natural carbohydrate sources to control strains of bacteria, fungi, or other microbes, when the mash or other aqueous carbohydrate source is intended for ethanol production by fermentation. First, the activation time and time until lysis of certain phages can be unacceptably high. Second, producers generally like the antimicrobial formulations to be shelf stable. Phages that are dormant often have even greater activation time and time until lysis than do phages from freshly lysed cells. The viral product may not have a significant effect until two or more infection/lysis cycles are completed, thereby increasing the concentration of the phages. Third, the presence of increasing ethyl alcohol concentrations can inhibit phage activity, either by extending time until lysis or inactivating a portion of the phages. Fourth, active phages are normally specific to one or a few microbes, but mash or other aqueous carbohydrate sources generally have a large number of undesired microbes.

Advantageously, in one embodiment, the viral controls are used in concert with one or more of a (usually substantially water insoluble) pristinamycin-type antimicrobial agent, a (usually substantially water insoluble) polyether ionophore antimicrobial agent, or both, wherein the term “substantially water insoluble” means the antimicrobial agent has a solubility in pure water at 20° C. of about 0.1 grams per liter or less. Such agents are effective at concentration ranges between about 0.3 to 15 mg/L, depending on the agent selected. Indeed, the pristinamycin-type antimicrobial agent and/or polyether ionophore antimicrobial agent may be the primary anti-microbial agent, where viral products described herein act on resistant strains of lactobacilli to prevent those resistant strains from becoming entrenched. Alternatively, the viral products described herein may be the primary antimicrobial agent, but because viruses tend to be extremely specific, the pristinamycin-type antimicrobial agent and/or polyether ionophore antimicrobial agent may need to be periodically added to provide a wider antibiotic activity.

As an alternative to the above, or in addition to the above, viral compositions can be prepared, where the viral compositions are prepared by: 1) forming a small batch of mash from representative feedstock; 2) allowing the feedstock to incubate in the absence of yeast, thereby accelerating growth of undesired microbes; 3) adding a multi-phage, high titre phage composition (either a shelf-stable composition or a composition prepared such as described above) which can be used to introduce a high and effective titre of lactococcal phages (and other desirable phages as needed) to the mash; 4) incubating the mash, advantageously until at least one lysis cycle has been achieved; 5) optionally but advantageously inactivating the undesired microbes in the small batch of mash by heat, chemicals, or antibiotics, including especially a pristinamycin-type antimicrobial agent and/or a polyether ionophore antimicrobial agent; and 6) adding this small batch of active-phage-rich mash to the process mash to undergo fermentation, either before or soon after fermentation starts. This process has a number of advantages. First, active phages which are specific to actual microbes present in the feedstock will be produced in abundance, while phages which may be specific to microbes which are not in the feedstock may be activated though not multiplied during the incubation period. Second, the small batch of active-phage-rich mash added to the process mash to undergo fermentation can be used as a carrier for the pristinamycin-type antimicrobial agent and/or polyether ionophore antimicrobial agents, which are difficult to solubilize and disperse. Third, the presence of microbes in the small batch of mash that might be resistant to the phages and to the added microbial agents or other sterilizing methods can be quickly identified.

While the invention is described for use in yeast ((Saccharomyces) dominated mash fermentation, the specificity of viral agents make them extremely useful when other non-yeast microbes are used to convert carbohydrates into useable fuels, including when recombinant Escherichia coli are used to convert various carbohydrates into ethanol.

1. A method of controlling microorganisms in the fermentation production of ethanol for fuel, comprising adding a treatment additive to mash, said treatment additive comprising a sufficient amount of lactococcal phages to provide add 10³ phages per ml of mash.

2. The method of claim 1, wherein the treatment additive comprises a sufficient amount of lactococcal phages to add about 10⁴ phages per ml of mash.

3. The method of claim 1, wherein the treatment additive comprises a sufficient amount of lactococcal phages to add about 10⁵ phages per ml of mash.

4. The method of claim 1, wherein the treatment additive comprises a sufficient amount of lactococcal phages to add about 10⁶ phages per milliliter of mash.

5. The method of claim 1, wherein the treatment additive is a liquid comprising between 10⁹-10¹² phages per milliliter of treatment additive.

6. The method of claim 1, wherein the treatment additive is sufficient to keep the presence of the undesired lactobacilli to a level below about 1 times 10⁶ viable cells per milliliter of mash.

7. The method of claim 1, wherein the treatment additive is sufficient to keep the presence of the undesired lactobacilli to a level below about 5 times 10⁵ viable cells per milliliter of mash.

8. The method of claim 1, wherein the treatment additive comprises phages from at least two of the 936, c2, and P335 groups.

9. The method of claim 1, wherein the treatment additive comprises phages from each of the 936, c2, and P335 groups.

10. The method of claim 1, wherein the treatment additive is added to mash in a fermentor.

11. The method of claim 1, wherein the treatment additive comprises several viruses specific against the number of different Lactobacilli that have been isolated from fuel ethanol plants.

12. The method of claim 1, wherein the treatment additive is dry and has a shelf life of at least a month without special refrigeration

13. The method of claim 1, wherein the treatment additive comprises phages the 936 group.

14. The method of claim 1, wherein the treatment additive comprises phages from the c2 group.

15. The method of claim 1, wherein the treatment additive comprises phages from the P335 group.

16. The method of claim 1, wherein the treatment additive comprises phages from at least one of the 936, c2, and P335 groups, and further comprises phages from at least one of the P034 and KSY1 groups.

17. The method of claim 1, wherein the treatment additive comprises bacteriophages and trehalose.

18. The method of claim 1, wherein the treatment additive comprises an aqueous suspension and further comprises a buffering agent that controls a pH level to between 4 and 9.

19. The method of claim 1, wherein the treatment additive further comprises a divalent alkaline earth metal salt, salts of gluconic acid, or both.

20. The method of claim 1, wherein the treatment additive is formed by
a) preparing a portion of mash from representative feedstock and water;
b) optionally, allowing the portion of mash to incubate in the absence of yeast, thereby accelerating growth of undesired microbes;
c) adding a multi-phage, high titre phage composition comprising lactococcal phages to the mash;
d) incubating the mash, advantageously until between about one and three lysis cycle has been achieved;
e) optionally inactivating the undesired microbes in the portion of mash by heat, chemicals, or antibiotics, including especially a pristinamycin-type antimicrobial agent and/or a polyether ionophore antimicrobial agent; and
f) adding this small batch of active-phage-rich mash to the a second portion of mash to undergo fermentation, either before or soon after fermentation starts.
